(19) United States
(12) Patent Application Publication
(10) Pub. No.: US 2008/0208459 A1
(43) Pub. Date: Aug. 28, 2008

(54) Road-map-data configuration and navigation apparatus

(75) Inventors: Seiji Takahata, Okazaki-shi (JP); Motohiro Nakamura, Okazaki-shi (JP)

Correspondence Address: BACON & THOMAS, PLLC, 625 SLATERS LANE, FOURTH FLOOR, ALEXANDRIA, VA, 22314, US

(73) Assignee: AISIN AW CO., LTD., Anjo-shi (JP)

(21) Appl. No.: 12/068,479

(22) Filed: Feb. 7, 2008

(30) Foreign Application Priority Data
Feb. 13, 2007 (JP) 2007-032351

(51) Int. Cl. G01C 21/26

(52) U.S. Cl. 701/208; 701/200

(57) ABSTRACT

A computer readable medium having stored thereon road-map-data including pieces of link information having different accuracy levels based on the accuracies of sources of the link information, whereby a computer is able to appropriately configure road-network data, on the basis of an accuracy level given in each of the pieces of link information. The road-map-data includes the road-network data representing roads as links and including connection relationships among the links, and the pieces of link information used to configure the road network data. Each piece of link information for a given link includes accuracy level information based on the accuracy of the source of that piece of link information.

### BACKGROUND OF THE INVENTION

1. Field of the Invention

The present invention relates to a computer-readable medium having stored thereon road-map-data for use in, for example, a navigation apparatus. The present invention also relates to a navigation apparatus having application programs that utilize the stored road-map-data.

2. Description of the Related Art

Known navigation apparatus operates to display the location of the navigation apparatus and to provide guidance along a route to a destination, using road-map data representing information for existing roads. Such road-map data is digital data which includes road-network data configured as combinations of nodes and links. Generally, the nodes are coordinate points representing intersections of roads, curves, and the like. The links connect the nodes to form a road network.

An item of link information includes an attribute of the link. The attribute is, for example, a link number, coordinates of the starting point and the endpoint of the link, a length corresponding to the link, type or classification of the road forming the link, the width of the road, traffic regulation, or the like. See for example, paragraphs 17, 18, etc. of Japanese Unexamined Patent Application Publication No. 6-323861.

### SUMMARY OF THE INVENTION

The level of accuracy of such an item (piece) of link information will differ in accordance with the source used to collect data for the attribute. More specifically, attributes that are lengths obtained by measuring existing roads, such as coordinates of a node used as the starting point or the endpoint of a link, and the length of a link, are influenced by the accuracy of the particular source. Examples of different sources include topographic maps, town maps, city-planning maps, road maps, aerial photographs, and measured data obtained by a measuring vehicle traveling the roads. In the related art, even when data is collected for attributes of links, with different accuracy levels from different appropriate sources, such as a frequency of use of a road corresponding to each of the links, the road-network data is configured from plural pieces of link information having a single accuracy level. In other words, in the road-network data in the related art, even when a piece of link information is generated by a source with a high level accuracy, that piece of link information is rounded off to the same accuracy level as that of a piece of link information generated by a source with low accuracy.

However, recently, the utilization of the road-network data which includes a significant amount of information for a plurality of applications other than the usual applications of a general navigation apparatus in the related art has been strongly demanded. For example, there exists a demand for utilization of such road-network data for other applications improving the amenities and/or the safety of an automobile in which the navigation apparatus is mounted. Some of these applications must use link information having a higher accuracy than that required for use in the navigation apparatus of the related art. Even in its ordinary applications, a navigation apparatus of the related art may provide, for example, more detailed guidance using link information with a higher level of accuracy. However, use of high accuracy information for all links included in the road-map data, unfortunately, results in an increase in the cost of collecting information, and an increase in the amount of data in the road-map database. Accordingly, it is necessary to generate items (pieces) of link information by making the most of the accuracy of each source, in forming the road-network data.

Accordingly, it is an object of the present invention to provide a computer-readable medium storing road-map-data in a configuration including pieces of link information having a plurality of different accuracy levels which vary with the accuracies of sources and that allows use of the road-network data, for each item of link information, on the basis of the accuracy level of each individual piece of link information.

The road-map-data, stored on a computer-readable medium in accordance with the present invention, includes road-network data representing the roads as links and including connection relationships among the links, and link information for each of the links within the road network data. The link information includes accuracy level information based on the accuracy of the source of the link information. This stored road-map-data, when used by a computer to configure links, allows the computer to configure each link in accordance with the accuracy level for that link.

As noted above, the road-map-data accuracy level information indicative of the accuracy of the source of each item of the link information, i.e. the amount of detail in the description of the link that is provided by the source. Accordingly, the road-network data can be appropriately configured using pieces of link information with a plurality of different levels. An application program, in using the aforementioned road-network data, reads the accuracy level for each piece of link information retrieved from the road-network data. Therefore, the application program using the aforementioned road-network data can determine, for each piece of link information, whether or not the road-network data can be used. Accordingly, since the road-network data can be used on the basis of the level of accuracy for each piece of link information, the number of types of application programs using the same road-network data can be increased.

In using the road-map-data structure in the present invention, the accuracy level information is information giving a value for level of accuracy (amount of detail) which is predetermined on the basis of the accuracy of each of various sources.

Thus, the accuracy level information included in the link information is a value representing a quantitatively predetermined level of accuracy. In the case of different sources, when the sources have the same accuracy, all link information can be described as having the same level of accuracy. Accordingly, the link information can be constantly maintained within a range of the value for level of accuracy without being influenced by its source. When the number of the types of sources is increased in the future, the link information can be updated without increasing the amount thereof.

In the road-map-data according to the present invention, the link information may further include density information that is determined on the basis of an accuracy level given in the accuracy level information and that describes the density of interpolation points for formation (configuration) of the links, and interpolation-point-offset coordinates that are represented as offset values defined between adjacent interpolation-points used in formation of the links.

The interpolation points are coordinate points for describing (configuring) the links. For this reason, when the accuracy of a source is high and therefore the accuracy level of link information therefrom is high, it is preferable that the interpolation points have a high density. Conversely, when the accuracy of a source is low, information obtained from the source is insufficient to dispose the interpolation points in a high density. In such a case, the interpolation points can be disposed only at dummy positions to achieve a high density. As a result, the amount of link information is unnecessarily increased. However, in the present invention, since the density of the interpolation points is determined on the basis of the accuracy level given in the accuracy level information, the interpolation points can be appropriately and efficiently set.

Additionally, because the density information and information concerning offset are separately defined, a unified offset unit for interpolation-point-offset coordinates can be used for links having different density information. For example, by setting one offset unit that is common to all of the links, the amount of data can be reduced.

In the road-map-data configuration according to the present invention, the link information includes density information that is determined on the basis of the accuracy level given in the accuracy level information and on the basis of the formations (configurations) of the links. The density information describes the density of interpolation points for interpolating the formations of the links, and interpolation-point-offset coordinates that are represented using offset values defined between adjacent interpolation-points in the links.

When the formations (configurations) of the links are not lines or curves with fixed curvatures but highly irregular formations, it is preferable that the interpolation points, which are coordinate points for defining the formations of the links, have a high density. Where the accuracy of a source is high and therefore the level of accuracy of link information is high, is preferable that the interpolation points have a high density. On the other hand, where the links have a regular formation, such as a line, there is a high probability that the interpolation points need not have a high density even when the accuracy of the source is high. In such a case, the disposition of the interpolation points in a high density would only result in an unnecessary increase in the amount of the link information. Likewise, where the accuracy of a source is low, information obtained from the source is insufficient to dispose the interpolation points in a high density. In such a case, the interpolation points can be disposed only at dummy positions to achieve a high density. As a result, the amount of link information would be unnecessarily increased. However, in the present invention, since the density of the interpolation points is determined on the basis of the accuracy level given in the accuracy level information and on the basis of the formations (configurations) of the links, the interpolation points can be efficiently disposed to give an appropriate density.

In the road-map-data structure employed in the present invention, the density information is represented as a function (“magnification”) of the density of the most dense interpolation points, and is represented as an exponent for the magnification defined as a multiple of two.

For example, when the magnification for the maximum density of the interpolation points is eight, the magnification value can be represented as three, which is the exponent or power of two (8=2³). Although four bits are necessary to represent an 8× magnification in binary numbers, three, the exponent of two which gives 8, can be represented using two bits. In other words, by representing the magnification density as an exponent of two, the amount of data can be reduced by one-half. Although only two bits can be eliminated for one of the links, a large positive effect (reduction) is obtained when considering the whole of the road-network data.

The navigation apparatus of the present invention includes: a map database that contains, stored therein, road-map-data of the foregoing structure; an apparatus-location-detection unit that detects location (or current location) of the navigation apparatus; and a plurality of application programs that are executed using that stored road-network data. Each of the application programs is executed on the basis of an accuracy level required for that application program, and is executed using the link information having an accuracy level (next) higher than the required accuracy level.

As described above, the road-map-data structure according to the present invention includes the accuracy level information based on the accuracy of the source of the link information. Accordingly, each of the application programs that run with the road-network data structured as described above can be executed on the basis of an accuracy level required for that application program, using the link information having accuracy level information for an accuracy level higher than the required accuracy level. The application program that uses the road-network data can determine, for each piece of link information, whether or not the road-network data can be used. Accordingly, since the road-network data can be used in accordance with the accuracy level for each piece of link information individually, the range of types of application programs that can use the same road-network data is expanded.

### BRIEF DESCRIPTION OF THE DRAWINGS

FIG. 1 is a block diagram of a navigation apparatus according to an embodiment of the present invention.

FIG. 2 is an illustration of an example of a road network.

FIG. 3 is a table illustrating one example of the relationships between different sources of link information, accuracy levels and applications.

FIG. 4 is an illustration of an example of representation of density of interpolation points as density information.

FIG. 5 is a table illustrating one example of the relationships between different sources of link information, accuracy levels, density information for interpolation points and applications.

### DESCRIPTION OF THE PREFERRED EMBODIMENTS

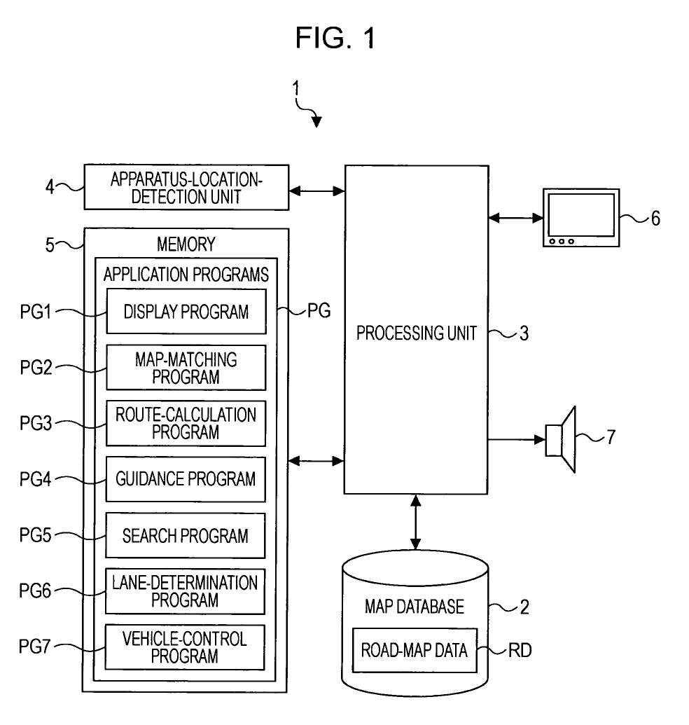

Preferred embodiments of the present invention will be described with reference to the accompanying drawings. As shown in FIG. 1, a navigation apparatus 1 according to an embodiment of the present invention includes a plurality of application programs that are executed utilizing a road-map-data configuration according to the present invention. By execution of these application programs, the navigation apparatus 1 can provide navigation functions including apparatus-location (geographical location) display, destination searching, searching for a route from a starting point to a destination, and guidance to a destination along the route determined by search.

As shown in FIG. 1, the navigation apparatus 1 has functional units including a map database 2, a processing unit 3, an apparatus-location-detection unit 4, a memory 5, a display unit 6, and a sound-output unit 7. Each of the functional units is designed to use the processing unit 3, which is basically a microprocessor, a digital signal processor (DSP), or the like. Alternatively, a part or all of the functional units, including the map database 2, the apparatus-location-detection unit 4, and the memory 5, may be built into the microprocessor or the DSP. Each of the functional units is in the form of hardware, software (a program), or both hardware and software.

In this embodiment, the application programs PG include seven programs PG1 to PG7, i.e., a display program PG1, a map-matching program PG2, a route-calculation program PG3, a guidance program PG4, a search program PG5, a lane-determination program PG6, and a vehicle-control program PG7.

The display program PG1 is a program for displaying, for example, a map showing the vicinity of the location of the apparatus, the vicinity of the destination, and/or the location of the apparatus on the map, on a display screen of the display unit 6. The map-matching program PG2 is a program for map matching in which the location of the apparatus detected by the apparatus-location-detection unit 4 is matched with a road on the map. The route-calculation program PG3 is a program for determining (calculating), for example, a route from the location of the apparatus to the destination that is input through the display unit 6. The guidance program PG4 is a program for providing guidance along the route to the destination determined by the route search (calculation), in the form a guidance display on the display screen of the display unit 6 and/or audio guidance provided by the sound-output unit 7. The search program PG5 is a program for searching for the destination, a point to be displayed on the map, and the like, on the basis of an address, a phone number, the name of a facility, a genre, or the like.

The lane-determination program PG6 and the vehicle-control program PG7 are used where the navigation apparatus 1 is mounted in an automobile. The lane-determination program PG6 is a program for determining the lane of a road in which a vehicle is traveling. The lane-determination program PG6 may function to output information to an operation-control apparatus of the vehicle in order to continue traveling in the determined lane. The vehicle-control program PG7 is a program for outputting information used to assist an operation, such as deceleration for stopping at a stop line or the like, or adjustment of a stop position, to the operation-control apparatus of the vehicle.

The map database 2 is a database in which road-map data RD (road-network data), utilized by the processing unit 3 to execute the application programs PG described below, is stored. The road-map data RD has a distinctive road-map-data configuration (structure) in the present invention. The map database 2 includes a storage medium, (“computer-readable medium”) such as a disk (an optical disk, a magnetic disk, or a magneto-optical disk) or a memory, and a reader, such as a disk drive, as hardware. It is preferred that the storage medium be a rewritable medium, such as a hard drive or a flash memory, so that the road-map data RD can be easily updated.

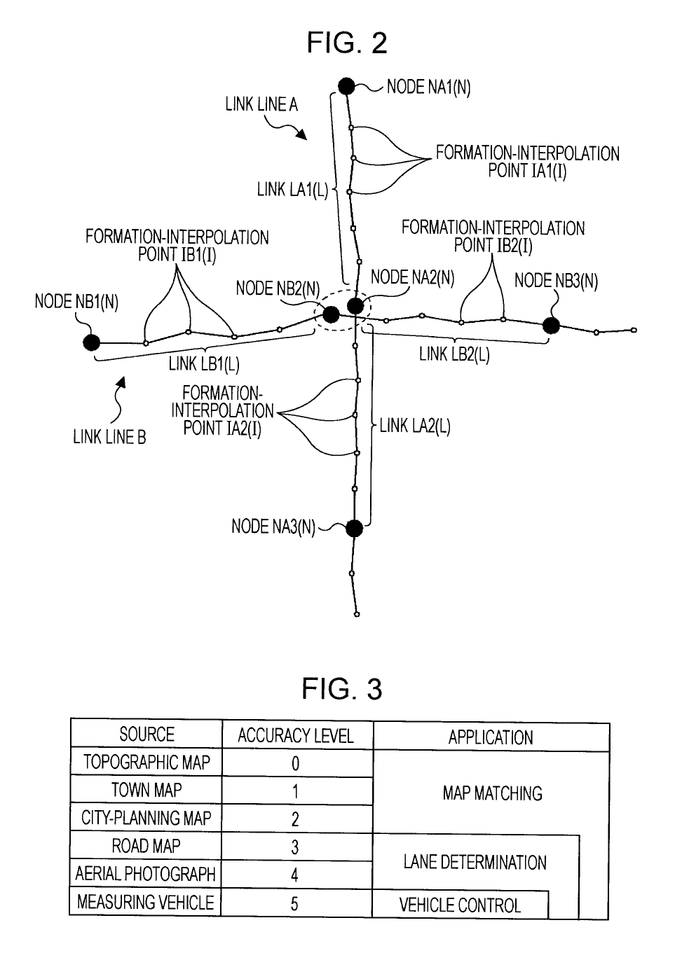

In the map database 2, not only the road-map data RD, but also various other types of data (data for guidance) that are used for display, guidance, search, and the like in the application programs PG, are stored. More specifically, this data includes image data, sound data, and data of points of interest (POI). Each of these bodies of data is stored in association with, for example, links and nodes, which are described below with reference to FIG. 2, included in the road-map data RD.

In the example of a road network shown in FIG. 2, there are two link lines, namely, link lines A and B, each consisting of a plurality of links L. The link line A includes nodes N (NA1 to NA3 represented by black points in FIG. 2), links L each of which connects between two nodes N (LA1 and LA2 represented by solid lines in FIG. 2), and a group of formation-interpolation points I (hereinafter, “interpolation points”) that define the configuration of each of the links L (IA1 and IA2 represented by in FIG. 2). Similarly, the link line B includes nodes N (NB1 to NB3 represented by black points in FIG. 2), links L each of which connects between two nodes N (LB1 and LB2 represented by solid lines in FIG. 2), and a group of interpolation points I that define the configuration of each of the links L (IB1 and IB2 represented by empty points in FIG. 2). The road-map data RD is data indicating the configuration of these link lines.

For each of the links L making up the link lines, there is an item of link information for the link L, such as an attribute of the link L. For example, attribute information for the link LA1 in the link line A includes at least identification of the node NA1 as the starting point, the node NA2 as the endpoint, and five interpolation points I disposed at a predetermined spacing. Further, each item (piece) of link information includes accuracy level information giving the level of accuracy of the link L, a predetermined spacing for formation-interpolation points i, and the like. The predetermined spacing is density information in this embodiment of the present invention.

Although the node NA2 of the link line A and the node NB2 of the link line B are shown at different positions in FIG. 2, the nodes NA2 and NB2 are the same node N, representing the same crossing. Accordingly, in the road-map data RD, data corresponding to the node N is managed for each of the link lines A and B. In other words, data corresponding to the node N representing the same crossing is stored for each of the link lines A and B. Additionally, the data corresponding to the node N at the crossing is the same for both of link lines A and B.

Referring again to FIG. 1, the apparatus-location-detection unit 4 functions to detect the present location of the navigation apparatus 1. For this purpose, the apparatus-location-detection unit 4 has, for example, a global positioning system (GPS) receiver, an orientation sensor, a distance sensor, or the like. The apparatus-location-detection unit 4 generates or obtains information concerning the coordinates of the present location, information concerning the direction of travel, and the like and outputs the thus obtained information to the processing unit 3.

The display unit 6 is a unit with a display screen, such as a cathode-ray tube (CRT) or a liquid crystal display, and has also a touch panel or a control switch, which is operatively connected to the display screen. The sound-output unit 7 includes a speaker, an amplifier, or the like. The sound-output unit 7 may be mounted in the unit 6. The display unit 6 and the sound-output unit 7 are connected to the processing unit 3, and provide visual and audio output, respectively, generated by execution of processes including a routine by which the location of the apparatus is specified, a routine in which a route between two points is searched, a routine for output of route guidance, and a routine in which the destination is searched, in accordance with operations of the processing unit 3. The display unit 6, which includes a touch panel or a control switch, also serves as a control-input unit that accepts a control input by a user and that transmits the content of the control input to the processing unit 3.

As described above, the navigation apparatus 1 includes the application programs PG that run with utilization of the road-map data RD having a unique road-map-data structure according to the present invention. Each of the application programs PG1 to PG7 is executed by the processing unit 3 on the basis of a level of accuracy required for that particular application program, using link information having a level of accuracy information (next) higher than the required accuracy level.

Road-map information is generated on the basis of a topographic map a town map or a city-planning map whose scale is larger than that of the topographic map, a road map with specifications of roads, an aerial photograph or a satellite photograph that is taken from a high altitude, measured data that is measured by a measuring vehicle in travel along the roads, and so forth. The topographic map, the town map, the city-planning map, the road map, the aerial photograph, and the measuring data are different sources of the link information for the links L forming the road network. The levels of accuracy of the items of link information will be different for the different types of sources. For example, because the topographic map is drawn to a scale of 1 to 25000 for Japan, the accuracy of the topographic map is lower than that of a smaller scale map such as a town map or city-planning map. The level of accuracy of the road map and the aerial photograph is higher than that of a town map or a city-planning map, but is lower than that of the data as measured by travel of the measuring vehicle.

If a measuring vehicle has traveled all of the roads corresponding to the links L to measure data, all of the road-map data RD can consist of items of link information of a high accuracy. However, the travel of the measuring vehicle along all of the roads is not realistic in terms of time or cost. Additionally, data with an accuracy as high as that of the data measured by the measuring vehicle is not necessary for execution of programs for general navigation functions, such as apparatus-location display, map matching, route calculation, and guidance. In contrast, data with a high level of accuracy is necessary for execution of programs related to vehicle travel control, such as control for maintaining a travel lane or assistance in stopping at a stop line.

For this reason, in this embodiment, the road-map-data includes items of link information for the links L in the road-map data RD, each of which items has accuracy level information corresponding to the accuracy of the source of the item of link information.

Each of the application programs PG1 to PG7 runs on the basis of an accuracy level required for that application program, using items of link information including accuracy level information indicating an accuracy level higher than the required accuracy level.

FIG. 3 shows an example in which accuracy levels are set in steps in correspondence with the sources. In this manner, items of accuracy level information are level values predetermined in accordance with the accuracies of the different types of sources. In this example, the accuracy level 0 is the lowest accuracy level, and the accuracy level 5 is the highest accuracy level. FIG. 3 represents only one example, and the setting of accuracy levels and/or the number of steps of accuracy level are not so limited.

In this example, for a piece (item) of link information whose source is a topographic map, an accuracy level of 0 is set on the basis of the accuracy of the topographic map. For a piece of link information whose source is a town map, an accuracy level 1 is set on the basis of the accuracy of the town map. For a piece of link information whose source is a city-planning map, an accuracy level 2 is set on the basis of the accuracy of the city-planning map. For a piece of link information whose source is a road map, an accuracy level 3 is set on the basis of the accuracy of the road map. For a piece of link information whose source is an aerial photograph, an accuracy level 4 is set on the basis of the accuracy of the aerial photograph. For a piece of link information whose source is measured data obtained by a measuring vehicle, the accuracy level 5 is set on the basis of the accuracy of the measuring vehicle.

A required accuracy level necessary for each of the application programs PG1 to PG7 is, for example, as described below.

As described above, for map matching and other general navigation functions, data with an accuracy as high as that of the data measured by a measuring vehicle is not necessary. In contrast, for lane determination for keeping in a travel lane, data with an accuracy higher than that used for map matching and the like is necessary. For vehicle control, such as assistance in stopping at a stop line, data with an accuracy much higher than that required for lane determination is necessary.

Accordingly, the map-matching program PG2 can be executed using a piece of link information having an accuracy level equal to or higher than zero as shown in FIG. 3. Additionally, although not shown in FIG. 3, the accuracy levels required for the display program PG1, the route-calculation program PG3, the guidance program PG4, and the search program PG5 are lower than the accuracy level required for the map-matching program PG2. Accordingly, these application programs can also be executed using link information having an accuracy level shown in FIG. 3 as equal to or higher than zero.

The lane-determination program PG6 can be executed using a piece of link information having an accuracy level equal to or higher than 3, as shown in FIG. 3.

The vehicle-control program PG7 can be executed using a piece of link information having an accuracy level shown in FIG. 3 as equal to or higher than 5.

For example, when the vehicle is traveling along a link of a road with an accuracy level of 5, all of the application programs PG1 to PG7 can be executed. However, when the vehicle is traveling along a road corresponding to a link with the accuracy level of 3 or 4, it is difficult to execute the vehicle-control program PG7. When the vehicle is traveling along a road corresponding to a link with an accuracy level equal to or lower than 2, it is difficult to execute the lane-determination program PG6 as well as the vehicle-control program PG7, and only the application programs PG1 to PG5 can be executed as in using a normal navigation apparatus. Additionally, it is preferred that the navigation apparatus 1 be configured to report to the user an increase or decrease in the number of executable application programs as the vehicle moves along lengths of a road represented as links with different accuracy levels. Accordingly, by utilizing accuracy level information, various types of applications can be provided for the user in addition to the normal navigation functions.

A piece of link information includes the interpolation points I for interpolating and defining the configurations (shapes or “formations”) of the links L as described above. When the links L are not lines or curves with fixed curvatures but highly irregular configurations, it is preferred that the interpolation points I defining the configurations of the links L be set in a high density. A case in which the accuracy of a source is high and the accuracy level of a piece of link information is high, it is preferred that a high density of the interpolation points I be formed. Conversely, when the accuracy of a source is low, information obtained from the source is insufficient to form the interpolation points I in a high density. In such a case, the interpolation points I can be disposed only at dummy positions to achieve a high density. As a result, the amount link information for a given link is unnecessarily increased. Accordingly, in this embodiment, a piece of link information is determined (formed) on the basis of an accuracy level, and includes density information for the density of the interpolation points I.

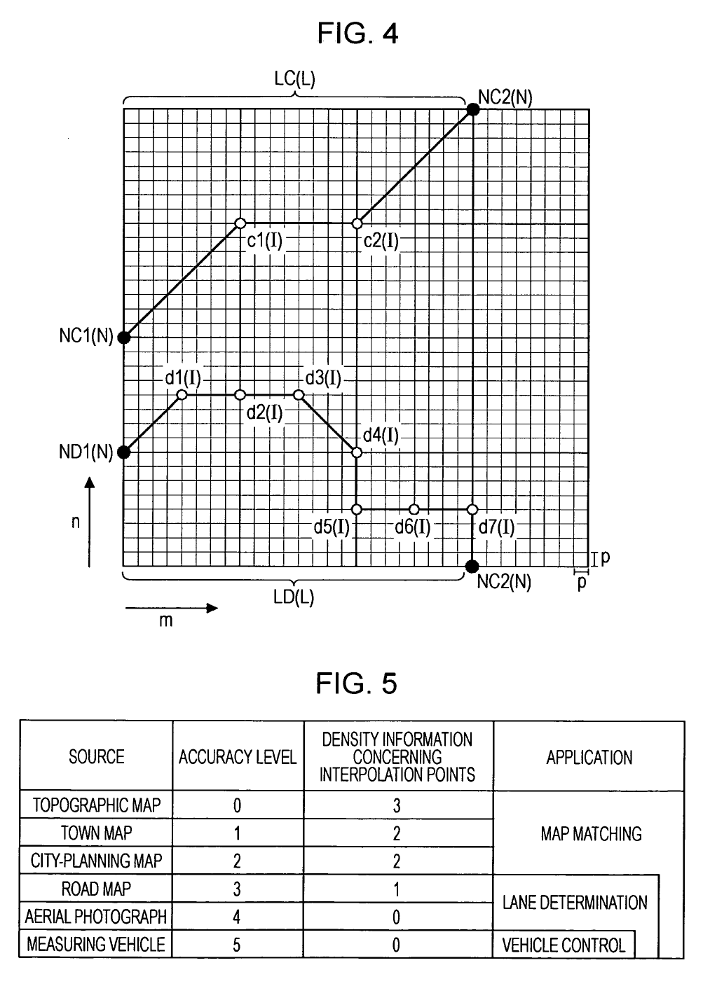

FIG. 4 illustrates an example of the relationship between the density of the interpolation points I and the density information. The grid shown in FIG. 4 represents a coordinate map showing spacings p obtained in a case where the interpolation points I are disposed in the highest density. In the grid shown in FIG. 4, thick lines are drawn for every eight spacings p on the coordinate map. Referring to FIG. 4, two links, namely, links LC and LD, are shown as examples. The link LC has a starting point at node NC1, and an endpoint at node NC2 and is an example of a link having a low density of interpolation points I (c1 and c2). The link LD, has starting point at node ND1 and an endpoint at node ND2 and is an example of a link in which interpolation points I (d1 to d7) have a density higher than those of the link LC.

The link LC has interpolation points I disposed at every eight spacings p in the n direction and the m direction. On the other hand, the link LD has interpolation points I disposed at every four spacings p in the n direction and the m direction. Additionally, for each of the interpolation points 1, an offset value (spacing) between adjacent interpolation points I is provided so that the interpolation points I have offset coordinates indicating the configuration of the link L which includes these interpolation points I.

For example, the interpolation point c1 is next adjacent the node NC1, which is the starting point of the link LC, and is spaced from the starting NCI point of the link LC toward the endpoint NC2. More specifically, the interpolation point c1 is positioned at eight spacings p in the m direction and eight spacings p in the n direction from the node NC1 that is the starting point. Accordingly, interpolation-point-offset coordinates (m, n) of the interpolation point cl are represented as (8, 8). Similarly, the interpolation point c2 is positioned at eight spacings p in the m direction and zero spacings p in the n direction from the interpolation point c1 adjacent to the interpolation point c2. Accordingly, interpolation-point-offset coordinates (m, n) of the interpolation point c2 are represented as (8, 0).

The interpolation points I on the link LC have a low density wherein their spacing on the link LC is equivalent to eight spacings p of the grid. Accordingly, in representing the density of the interpolation points I on the link LC, the interpolation point c1 is treated as positioned at one in the m direction and one in the n direction from the node NC1 that is the starting point, where one unit is equivalent to eight spacings p (=p×8). Similarly, the interpolation point c2 is positioned at one in the m direction and zero in the n direction relative to the interpolation point c1, where one unit is equivalent to eight spacings p. Accordingly, when the density of the interpolation points I on the link LC is taken into consideration, the interpolation-point-offset coordinates of the interpolation point c1 are represented as (1, 1), and the interpolation-point-offset coordinates of the interpolation point c2 are represented as (1, 0). Thus, the density information for interpolation points I of the link LC is information defining eight spacings p as the placement density of the interpolation points I of the link LC.

The interpolation point d4 of the link LD is the next adjacent to the interpolation point d3 in the direction toward the endpoint. More specifically, the interpolation point d4 is positioned four spacings p in the m direction and negative four spacings p in the n direction from the interpolation point d3. Accordingly, the interpolation-point-offset coordinates of the interpolation point d4 are represented as (4, −4). Similarly, the point-offset coordinates of the interpolation point d5 are represented as (0, −4).

The density of the interpolation points I on the link LD is higher than that of the interpolation points I on the link LC, and the spacing between the interpolation points I on the link LD is equivalent to four spacings p, each of which is the smallest unit of the grid. Accordingly, when the density of the interpolation points I on the link LD is taken into consideration, the interpolation point d4 is positioned at one in the m direction and negative one in the n direction from the interpolation point d3, where one unit is equivalent to four spacings (units) p (=p×4). Similarly, the interpolation point d5 is positioned at one in the m direction and negative one in the n direction from the formation-interpolation point d4, where one unit is equivalent to four spacings p. Accordingly, when the density of the interpolation points I on the link LD is taken into consideration, the interpolation-point-offset coordinates of the interpolation point d4 are represented as (1, −1), and the interpolation-point-offset coordinates of the interpolation point d5 are represented as (0, −1). Thus, the density information for the interpolation points I of the link LD defines four spacings p as the density of the interpolation points I of the link LD.

As described above, when the interpolation-point-offset coordinates are represented in accordance with the density of the interpolation points I, all interpolation-point-offset coordinates can be represented using three values, i.e. 0, 1, and −1. In other words, all interpolation-point-offset coordinates can be defined using set units of distance, which are represented as 0, 1, and −1, independent of the number of spacings between the interpolation points I. By using the set offset units common to all of the links, the interpolation-point-offset coordinates can be represented using four bits, which are a sum of two bits in the m direction and two bits in the n direction. Because the density is set for each of the links L and each link L has a plurality of interpolation points 1, the total amount of data for all links is significantly reduced.

Furthermore, in a piece of density information, the highest density for interpolation points I, i.e., the scale (magnification) of the spacing p (for example, by four or eight), can be represented as a multiple (an exponent, 2 or 3) of 2 (4=2² or 8=2³).

Four bits are necessary to represent eight in binary numbers. However, when eight is represented as a power of two, the exponent of the power of two, e.g. 3, can be represented using two bits. In other words, by representing the scales of the density as an exponent of a power of two, the amount of data can be reduced by one-half. Although only two bits can be reduced for each one of the links L, a large positive benefit is obtained from the reduction for the whole of the road-map data RD.

In the example described above with reference to FIG. 4, the magnification (scale) of the placement density is only eight or four. When an exponent of the power of two for the magnification is set to one, a density with a 2× magnification is indicated. Similarly, when the exponent of the power of two for the magnification is set to zero, a density of 1× magnification (no magnification) is indicated.

As described above, a high accuracy source and a correspondingly high accuracy level for a piece of link information is preferred for setting the interpolation points I in a high density. Conversely, when the accuracy of a source is low, information obtained from the source is insufficient to provide a high density of the interpolation points I. In such a case, the interpolation points I can be disposed only at dummy positions to achieve a high density. As a result, the amount of information in a piece of link information is unnecessarily increased. Accordingly, density information included in each piece of link information is determined on the basis of the accuracy level indicated by a piece of accuracy level information.

FIG. 5 shows one example of the relationship between the source of a piece of link information and an accuracy level and density information for the interpolation points I.

In this example, where the source of the piece of link information is the topographic map (basic map), an accuracy level of 0 is set on the basis of the accuracy of the topographic map. At this accuracy level (0), it is difficult to obtain sufficient information to form a high density of interpolation points I. Accordingly, a piece of density information obtained from the topographic map is represented as three, which is the exponent of the power of two defining an 8× magnification.

The accuracy level for a piece of link information whose source is a town map is set as 1 on the basis of the accuracy of the town map. In this case, the interpolation points I can be disposed in a density higher than that in the case of link information based on the topographic map. Accordingly, a piece of density information obtained from the town map can be represented as two, which is the exponent of the power of two defining a 4× magnification.

The accuracy level for a piece of link information whose source is a city-planning map is set at 2 on the basis of the accuracy of the city-planning map. As in the case of the piece of link information based on the town map, the interpolation points I can be disposed in a density higher than that in the case of the piece of link information based on the topographic map. Accordingly, density information for a link, obtained from the city-planning map, can be represented as two, which is the exponent of the power of two defining a 4× magnification.

The accuracy level for a piece of link information whose source is a road map is set at 3 on the basis of the accuracy of the road map. The interpolation points I can be disposed in a density much higher than that in the case of link information based on the town map or the city-planning map. Accordingly, density information for a link obtained from the road map can be represented as one, which is the exponent of the power of two defining a 2× magnification.

The accuracy level for a piece of link information whose source is an aerial photograph is set at 4 on the basis of the accuracy of the aerial photograph and the interpolation points I can be disposed in the highest density. Accordingly, density information for a link obtained from the aerial photograph can be represented as zero, which is the exponent of the power of two defining a 1× magnification.

The accuracy level for a piece of link information whose source is a measuring vehicle is set at 5 on the basis of the measuring vehicle. As in the case of the piece of link information based on the aerial photograph, the interpolation points I can be disposed in the highest density. Accordingly, density information for a link obtained from the aerial photograph can be represented as zero, which is the exponent of the power of two defining a 1× magnification.

As described above, in the road-map-data structure utilized in the present invention, each item of link information includes accuracy level information based on the accuracy of the source of the piece of link information and a piece of density information for the interpolation points I based on accuracy level information. The application programs, which run with reference to the road-map data RD having this road-map-data structure can be executed on the basis of the level of accuracy required for each individual application program, using pieces of link information having the accuracy level which is next higher than the required accuracy level. Accordingly, the application programs can share the same road-map data, and be executed on an as needed basis, using the appropriate pieces of link information. Furthermore, since the navigation apparatus of the present invention utilizes road-map-data wherein each piece of link information is structured on the basis of the accuracy of the source of the particular piece of link information or on an as needed basis, the increase in the required amount of road-map data can be reduced.

### Other Embodiments

In the above-described embodiment, as shown in FIG. 5, each piece of density information is determined on the basis of an accuracy level given in a corresponding piece of accuracy level information. However, for example, in a case in which the links L have a regular formation, such as a line, the interpolation points I need not be disposed in a high density even when the accuracy of the source is high. In other words, the disposition of the interpolation points I in a high density for such regular links would be an unnecessary increase in the amount of link information.

A coefficient or an offset value based on the configuration of each link L may be given as density information for the interpolation points I. For example, when the links L have a regular formation, such as a line, an offset value 1 may be added to the exponent of the power of two. Steps defined by the offset value 1 and an offset value 2 may be set in accordance with how regular the shapes of the links are. It is also preferred that an upper limit of the exponent of the power of two be determined. For example, three may be set as the upper limit for the exponent of the power of two.

As described above, when a piece of density information (density information for one particular link) is determined on the basis of an accuracy level for the source of the information for that one link and on the basis of the configuration (shape) of that one link L, the amount of the road-map data can be reduced while a level of accuracy of the road-map data required for each of the application programs is maintained.

As described above, the present invention provides a navigation apparatus operating with road-map-data including pieces (items) of link information for different links with a plurality of accuracy levels based on the accuracies of sources, using the road-network data on the basis of the accuracy level given for each piece of link information. The invention also provides a computer-readable medium for causing a navigation apparatus to execute various navigation programs with less map (link) information data.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A computer-readable medium having stored thereon road-map-data comprising:
road-network data representing roads as links and including connection relationships among the links; and
link information for each link for configuring the road network data, the link information including accuracy level information indicative of the accuracy of a source of the link information;
whereby the road-map data, when utilized by a computer to configure links, will cause the computer to configure each link in accordance with the accuracy level information for that link.

2. The computer-readable medium according to claim 1, wherein the accuracy level information is information showing a level value predetermined on the basis of the accuracy of each of various types of sources.

3. The computer-readable medium according to claim 1, wherein the link information includes density information that is determined on the basis of an accuracy level given in the accuracy level information and that indicates the density of interpolation points to be set in configuring the link, and interpolation-point-offset coordinates which represent offset between adjacent interpolation-points to be used in configuring the link.

4. The computer-readable medium according to claim 1, wherein the link information for each link includes density information that is determined on the basis of an accuracy level given in the accuracy level information and on the basis of the configuration of the link and that prescribes the density of interpolation points for the configuration of the link, and interpolation-point-offset coordinates that represent offset between adjacent interpolation-points to be used in configuring the link.

5. The computer-readable medium according to claim 4, wherein the density information gives the density of interpolation points to be disposed in a link in configuring the link, and is expressed as an exponent of the numeral two.

6. The computer-readable medium according to claim 2, wherein the link information includes density information that is determined on the basis of an accuracy level given in the accuracy level information and that indicates the density of interpolation points to be set in configuring the link, and interpolation-point-offset coordinates which represent offset between adjacent interpolation-points to be used in configuring the link.

7. The computer-readable medium according to claim 2, wherein the link information for each link includes density information that is determined on the basis of an accuracy level given in the accuracy level information and on the basis of the configuration of the link and that prescribes the density of interpolation points for the configuration of the link, and interpolation-point-offset coordinates that represent offset between adjacent interpolation-points to be used in configuring the link.

8. The computer-readable medium according to claim 7, wherein the density information gives the density of interpolation points to be disposed in a link in configuring the link, and is expressed as an exponent of the numeral two.

9. A navigation apparatus comprising:
the computer-readable medium of claim 1 as a map database storing the road-network data;
an apparatus-location-detection unit that detects location of the navigation apparatus; and
a plurality of stored application programs that run utilizing the road-network data, each of the application programs being executed on the basis of an accuracy level required for the application program and executed using link information including accuracy level information indicating an accuracy level higher than the required accuracy level.

10. A navigation apparatus comprising:
the computer-readable medium of claim 2 as a map database storing the road-network data;
an apparatus-location-detection unit that detects location of the navigation apparatus; and
a plurality of stored application programs that run utilizing the road-network data, each of the application programs being executed on the basis of an accuracy level required for the application program and executed using link information including accuracy level information indicating an accuracy level higher than the required accuracy-level.

11. A navigation apparatus comprising:
the computer-readable medium of claim 3 as a map database storing the road-network data;
an apparatus-location-detection unit that detects location of the navigation apparatus; and
a plurality of stored application programs that run utilizing the road-network data, each of the application programs being executed on the basis of an accuracy level required for the application program and executed using link information including accuracy level information indicating an accuracy level higher than the required accuracy level.

12. A navigation apparatus comprising:
the computer-readable medium of claim 4 as a map database storing the road-network data;
an apparatus-location-detection unit that detects location of the navigation apparatus; and
a plurality of stored application programs that run utilizing the road-network data, each of the application programs being executed on the basis of an accuracy level required for the application program and executed using link information including accuracy level information indicating an accuracy level higher than the required accuracy level.

13. A navigation apparatus comprising:
the computer-readable medium of claim 5 as a map database storing the road-network data;
an apparatus-location-detection unit that detects location of the navigation apparatus; and
a plurality of stored application programs that run utilizing the road-network data, each of the application programs being executed on the basis of an accuracy level required for the application program and executed using link information including accuracy level information indicating an accuracy level higher than the required accuracy level.

14. A navigation apparatus comprising:
the computer-readable medium of claim 6 as a map database storing the road-network data;
an apparatus-location-detection unit that detects location of the navigation apparatus; and
a plurality of stored application programs that run utilizing the road-network data, each of the application programs being executed on the basis of an accuracy level required for the application program and executed using link information including accuracy level information indicating an accuracy level higher than the required accuracy level.

15. A navigation apparatus comprising:
the computer-readable medium of claim 7 as a map database storing the road-network data;
an apparatus-location-detection unit that detects location of the navigation apparatus; and
a plurality of stored application programs that run utilizing the road-network data, each of the application programs being executed on the basis of an accuracy level required for the application program and executed using link information including accuracy level information indicating an accuracy level higher than the required accuracy level.

16. A navigation apparatus comprising:
the computer-readable medium of claim 8 as a map database storing the road-network data;
an apparatus-location-detection unit that detects location of the navigation apparatus; and
a plurality of stored application programs that run utilizing the road-network data, each of the application programs being executed on the basis of an accuracy level required for the application program and executed using link information including accuracy level information indicating an accuracy level higher than the required accuracy level.
